(19) United States
(12) Patent Application Publication
(10) Pub. No.: US 2005/0047556 A1
(43) Pub. Date: Mar. 3, 2005

(54) Media platform testing

(76) Inventors: Mark E. Somerville, Merrimack, NH (US); Richard D. Ellison, Maynard, MA (US)

Correspondence Address: HEWLETT-PACKARD COMPANY;Intellectual Property Administration, P.O. Box 272400, Fort Collins, CO, 80527-2400, US

(21) Appl. No.: 10/647,822

(22) Filed: Aug. 25, 2003

(51) Int. Cl. H04M 1/24; H04M 3/22

(52) U.S. Cl. 379/9.01; 379/9

(57) ABSTRACT

Methods, systems, and devices are provided for media platform simulation. A method for testing a media platform includes selecting a number of scalable variables provided with a testing routine. The scalable variables are operable to define one or more application characteristics for different service applications. The testing routine is executed implementing the scalable variables. A performance of various media platform resources is measured while executing the testing routine. The measured performance is analyzed and can be output as categorized performance report data.

Media platforms as used in the telecommunications industry include hardware components, such as trunk lines, switches, routers, servers, and databases. Media platforms can also include software, application modules, firmware, and other computer executable instructions operable thereon. Modern media platforms are becoming more and more functional, or intelligent, in terms of the services they can provide in cooperation with the software tools that are provided thereon.

Telecommunications networks use computer based media platforms to provide enhanced telephone services such as toll-free 800 call routing, prepaid calling card services, voice mail, interactive voice response (IVR) applications, DTMF (dual tone multiple frequency) services, and virtual private network call routing in addition to regular phone services.

Providing enhanced telephone services to a media platform involves testing the response and behavior of the services in order to provision resources and predict user satisfaction.

Traditionally, test tools have been provided to test the signaling side of a service application, and separate test tools have been provided to test the media stream side of the service application. In both cases, the test tools are statically designed for testing a particular service application (e.g., IVR or DTMF) as associated with a particular media component, e.g., testing latency through a single T1, E1, or J1 media card. For example, some test tools can drive calls (or tones) into pre-written applications to assess how the application will handle routing the calls through the channels of a T1 card. The process of writing test applications to model each new enhance service application can be time consuming and costly. Additionally, the individual application approach, when applied to a particular media component, may provide a poor indication of how a media platform having many of the particular media component, e.g., multiple T1 media cards, will perform in an actual use setting.

Moreover, the test tools themselves are static and as such may not fairly model actual use settings. That is, a test tool may be designed to simulate a call rate of one call (1) per second. However this call simulation capability does not account for the fact that in an actual use setting call signals typically do not arrive in such a metered, static rate. The test tools also may not account for other actual use factors such as variable call duration. Additionally, an individual application test approach may not provide a realistic indication of how multiple service applications will interface when running together on a media platform. That is, the individual testing approach may not accurately indicate the load placed on the media platform resources in handling several different types of services on the same media platform.

The above described test tools for services on a media platform do not offer an accurate measurement of the full resource capability of a media platform when the media platform is in actual use. As a result, the full resources of a media platform will often be conservatively under-approximated to ensure satisfactory performance and, as such, a true resource capability of the media platform will be underutilized when placed in actual use.

### BRIEF DESCRIPTION OF THE DRAWINGS

FIG. 1A is a block diagram embodiment of a test tool and a media platform.

FIG. 1B illustrates an embodiment of a number of input variables representing one or more application characteristics of one or more service applications.

FIG. 1C illustrates an embodiment of a selected number of input variables representing one or more application characteristics of one or more service applications for executing a test routine.

FIG. 2A is a block diagram of an embodiment of a media platform simulator.

FIG. 2B illustrates an embodiment of a number of input variables representing configurable media platform resources.

FIG. 2C illustrates an embodiment of a selected number of input variables representing media platform resources for executing a test routine.

FIG. 3 illustrates a method embodiment for testing a media platform.

FIG. 4 illustrates another method embodiment for testing a media platform.

FIG. 5 illustrates another method embodiment for testing a media platform.

FIG. 6 is a block diagram embodiment of a telecommunications network including a media platform according to embodiments described herein.

### DETAILED DESCRIPTION

Different service applications are becoming more and more popular. Accommodating different service applications creates an additional load to media platforms. That is, additional resources are provisioned to ensure the different service applications properly function and provide user service satisfaction.

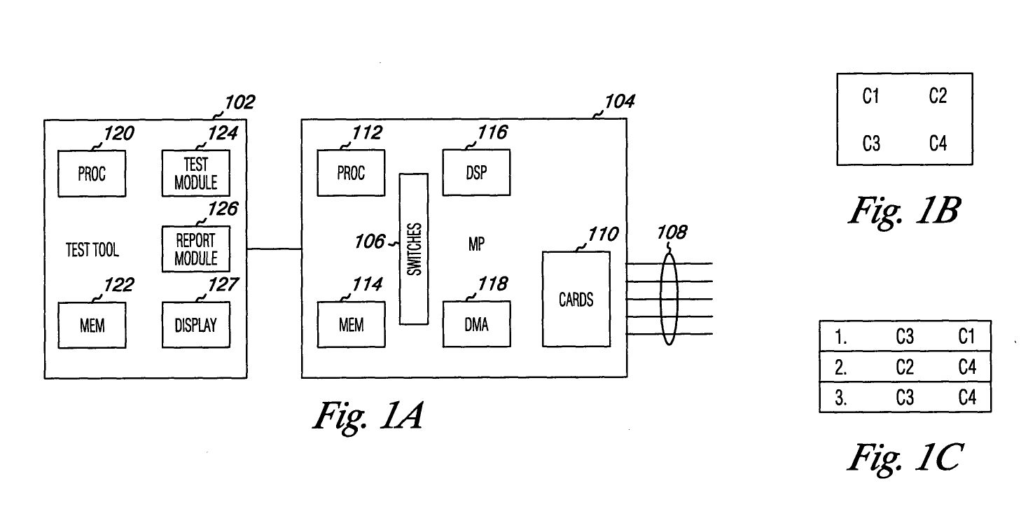

Embodiments of the present invention provide a programmable media platform test tool that can test one or more application characteristics of one or more telecommunication services and that can test various combinations media platform resources, either independently or in combination. Various embodiments are discussed that can provide integrated call signaling, e.g., the set up, tear down and bridging of calls, and media stream simulation, e.g., message or call content simulation. Embodiments are instrumented for signal and message response latency measurements, actual use call rates and duration, call distribution pattern, e.g., average number of calls over a particular period, and actual use call profiling, e.g., the level of interactivity. That is, embodiments are selectably variable and scaleable across many media channels, e.g., thousands of media channels. The programmability of these devices is illustrated in FIG. 1B, 1C, 2B, and 2C, respectively.

Embodiments can measure the affects of multiple application characteristics, such as call rate, call distribution patterns, and call duration, on media platform resources. Thus, the various test tool embodiments can measure how a platform's resources (e.g., processing capability, memory, and voice circuits, among others described below) will respond to service applications (e.g., IVR, DTMF, voice mail, etc).

Embodiments described in this application can be performed by software (e.g., a program having computer executable instructions), in connection with hardware, application modules, and the like. The program, or software, is executable on the systems and devices shown herein or otherwise. The invention, however, is not limited to a program written in a particular programming language. Programs, application modules and/or hardware, suitable for carrying out embodiments of the present invention, can be resident in one or more devices or locations or in a plurality of locations.

FIG. 1A is a block diagram embodiment of a test tool 102 coupled to a media platform 104. The media platform 104 can include hardware and software resources in the form of switches, routers, processors, digital signal processing (DSP) modules, memory, media cards, and the like which can operate on or according to computer executable instructions. For example, in the embodiment of FIG. 1A, the media platform 104 is illustrated as having a switch 106 and a number of media channels 108. The switch 106 can provide an interface to a media channel such as, for example, telephonic channels, the Internet, or private connections wired or wireless. The number of media channels 108 can be provided in the form of media cards such as T1, E1, and/or J1 media cards 110. Embodiments of the invention, however, are not limited to these examples.

Media cards are voice circuit based media channels. A DS0 is one example of a media channel and represents one 64 Kilo bits per second (Kb/s) channel. DS0s are the building blocks for media cards. A DS3 media card is the equivalent of 672 DS0s and provides a signal rate of 45.736 Mega bits per second (Mb/s). Twenty four (24) DS0s are provided in each T1 trunk or span of a media card for a signal rate of 1.544 Mb/s. Thirty one (31) DS0s are provided in each trunk or span of an E1 media card for a signal rate of 2.048 Mb/s. A J1 trunk or span of a media card is the Japanese specification equivalent to a T1 trunk or span of a media card.

As shown in the embodiment of FIG. 1A, the media platform can include a processor 112 and a memory 114. The processor 112 can operate on computer executable instructions as part of the control logic for controlling operations of the media platform 104. Computer executable instructions can be stored in the memory 114. Memory, as referred to herein, can include a form of computer readable media. Forms of computer readable memory include non-volatile and volatile memory such as Flash memory, read only memory (ROM), random access memory (RAM), and optical memory, among others. The hardware and software resources illustrated in the media platform embodiment of FIG. 1A, include a digital signal processing (DSP) module 116 and a direct memory access (DMA) module 118 such as described below.

As mentioned above, and as described further in connection with FIG. 6, media platforms provision (e.g., provide or supply) telecommunication services to users. For example, a media platform receives a call signal which can be originated by a local exchange carrier (LEC) and propagates the call signal to a switch such as switch 106. The DSP module 116 and DMA module 118 are used in connection with instructions from memory 114, executable on processor 112, to provision the call signal to a particular media channel 108 in order to complete the call signal's routing to an intended destination. By way of example and not by way of limitation, the DSP module 116 can analyze call signals, for processing and routing, using various algorithms such a Fast Fourier Transform. The DMA module 118 includes circuitry to route data (call data or otherwise) on the media platform, for example, from one memory to another, without using the processor 112 in every data transfer. As described in the introduction section a number of telephone services may be provided by applications available on a media platform and accessed by the hardware and software resources described above.

Examples of these telephone services include toll-free 800 call routing, prepaid calling card services, voice mail, interactive voice response (IVR) applications, DTMF (dual tone multiple frequency) services. As used herein IVR applications include applications which can process, e.g., using a DSP module, spoken voice signals and provide the call signal to a particular media channel 108 in order to complete the call signal's routing to an intended destination. And, as used herein, DTMF services include applications which can process the type of audio signals that are generated from pressing buttons on a touch-tone telephone and provide the call signal to a particular media channel 108 in order to complete the call signal's routing to an intended destination.

The test tool 102 includes a processor 120 a memory 122, a testing module 124, e.g., test module, and a test data analysis and output module 126, e.g., report module). The test tool 102 includes a set of computer executable instructions, e.g., program, for testing a variety of operations on the media platform 104. The program can be stored in the memory 122 and operated on by the processor 120. As will be understood upon reading this disclosure, the test tool is operable to drive call signals to the media platform 104. In this manner, the test tool 102 can test the performance of the hardware and software resources (e.g., processing capability, memory, and voice circuits, among others as listed above) of the media platform 104 as the same would respond to actual service applications, e.g., voicemail, toll-free 800 call routing, interactive voice response applications (IVR), dual tone multiple frequency (DTMF) services, as well as virtual private network call routing, running thereon.

Examples of telecommunication service applications which involve IVR and/or DTMF include caller information services such as calling a local cinema's telephone number for a listing of movie showings and times, calling a bank's telephone number to access account information, and/or calling a weather information number to receive weather forecasts. By way of example and not by way of limitation, an IVR service application would allow a caller to speak voice commands in response to recorded prompts, e.g., such as speaking a banking account number, or movie title, after a recorded prompt asking for “what account number” or what movie listing. In other examples, a DTMF service application would have a recorded prompt asking the caller to input the banking account number using keys on the phone, or to input the movie title using keys on the phone corresponding to the first several letters of the movie title. Sometimes a telecommunications service application involves a combination of IVR and DTMF responses. Embodiments of the invention are not so limited. Accessing voice mail remotely is another example which can use IVR, DTMF, or a combination thereof. That is, a caller may dial a voice mail access number from a phone and either speak, press keys on their phone, or a combination thereof in response to recorded prompts in order to access their voice mail messages.

In each of these examples, a caller who has dialed a number of the respective telecommunications service will experience a certain response time before receiving a recorded prompt, and will experience a certain response time after the information requested by the prompt has been entered.

As the reader will appreciate, the responsiveness of such telecommunication services is reflection of the call traffic. That is, the number of callers trying to dial the particular information number at the same moment in time. Call traffic can be measured in terms of call rate, call distribution pattern, length of recorded response, and duration of the call, examples of which are given below. The responsiveness of the particular telecommunication service will also be impacted by the resources (e.g., processing resources, memory resources, and number of voice circuits, among others listed above) that are allocated to a particular telecommunication service on a media platform 104.

In the embodiment of FIG. 1A, the testing module 124 receives instructions from the processor 120 and memory 122 to execute a particular testing routine on a media platform 104, e.g., a program to drive call signals to a media platform 104 to mimic actual call signals as would be placed by actual callers trying to access telecommunication services such as the examples given above. The testing module 124 can include hardware, firmware, software, or a combination thereof. The test data analysis and output module 126 can receive input data, e.g., measurement results data, from the testing module 124 and analyze the measurement and results data according to a number of performance criteria and output categorized performance report data. By way of example and not by way of limitation, the measurement result data may be a time measurement of how long a caller waited after dialing a number before receiving a recorded prompt. It may be a measurement of how long the caller waited for an additional response after entering the information requested by the prompt. The number of performance criteria and categorized performance report data can include programs which compare and organize output summaries of the measured system response times to one or more thresholds set according to a predicted tolerance of the caller to such wait delays. The test data analysis and output module 126 can also include hardware, firmware, software, or a combination thereof.

In the various embodiments, a program is executed according to a number of input variables representing one or more application characteristics of one or more service applications. The number of input variables representing one or more application characteristics are provided to the testing module 124 to execute a particular testing routine on the media platform 104. A particular testing routine can be selected from memory 122, or other form of library. And, a given testing routine can present a user of the test tool 102 with a number of associated input variables representing one or more application characteristics. The number of associated input variable can be selected via an input/output (I/O) device 127 on the test tool 102. The I/O device 127 can include a graphical user interface (GUI) and a keyboard combination. Embodiments of the invention, however, are not so limited.

FIG. 1B illustrates an embodiment of number of input variables representing one or more application characteristics of one or more telecommunication service applications. As noted above, the input variables can be presented to a user on a display 127 upon selection of a particular testing routine such as from memory 122. For ease of illustration, FIG. 1B shows example input variables as C1, C2, C3, and C4. These input variables can include a variable call rate, e.g., how frequently a call signal is generated (C1), a variable length of response representing what period of time elapses before a response signal or recorded prompt is provided, e.g., a caller presses a button on their phone for information and it takes 4 seconds for the system to respond (C2), a variable call distribution pattern, for example, an average of 3 calls driven into the system by the test tool every 2 seconds in a randomly distributed manner (C3), and a variable call duration representing a length of a call connection, e.g., a caller may typically be connected to a call for 45 seconds while listening to recorded listing of movie showings and time schedules at their local cinema (C4). The variable call rate and call distribution pattern can randomly be generated, such as for example by using a pseudo random number generator, to cycle through a number of different call rates and call distribution patterns.

By allowing a user of the test tool 102 to select these input variables, the test tool 102 does not have to include a specific program dedicated to testing one particular type of telecommunications service. Instead, by selection of different input variables, a user of the program embodiments on the test tool 102 can configure numerous testing routines as suited to testing various types of telecommunication services. Additionally, the telecommunication service application does not even have to be physically loaded onto the media platform 104 to test how the service application would respond on the media platform 104. Instead, once again by the selection of different input variables, a user of the program embodiments on the test tool 102 can configure numerous types of response behaviors to mimic the response behavior of various types of telecommunication services as if they were physically loaded onto a media platform 104. Examples are provided in connection with FIG. 1C.

FIG. 1C illustrates an embodiment of a selected number of input variables representing application characteristics of one or more telecommunication service applications. The example inputs shown have been selected or chosen from options such as those in FIG. 1B for purposes of executing a testing routine by the test tool 102 on a media platform 104. For illustration, to program, or configure a first (1) test routine a user has selectably chosen as an input variable that call signals be generated to produce an average of 3 call signals (C3) every 2 seconds (C1). The software program can use this input to cycle through many different combinations of 3 calls every 2 seconds to produce the selectably chosen pattern or rate. Thus, in this example, 2 call signals may be generated by the test tool 102 and driven into the media platform over the period of a first second of time and a third call signal may be generated over the period of a next second of time. As the program continues, three call signals may be generated in the period of a first second of time and no call signals may be generated in the next second of time. According to embodiments of the invention, a user can selectably vary the call rate and call distribution patterns in increments of milliseconds. Embodiments of the other inputs variables, described in this application, are scalable to similar detail. Embodiments of the invention, however, are not limited to this particular incremental example.

In a similar manner, a second test routine (2.) can be configured as shown in the embodiment of FIG. 1C, using I/O device 127. In the second test routine (2.) a variable length of response (C2) has been chosen as an input variable, and a variable call duration (C4) has also been selectably set for a given time length. By way of example, the length of response can be selected as a time period of 2 seconds and the call duration can be selected as a time period of 30 seconds. In the various embodiments, the program then applies the user chosen input variables in order to test the responsiveness of a media platform 104 to the selectably chosen length of response time and selectably chosen call duration. The program, however, can also randomize the actual length of response time and length of call duration around these chosen values as may likely occur in actual media platform use.

The embodiment of FIG. 1C further illustrates a third test routine (3.). In the third test routine (3.) a variable call distribution pattern has been selected. For example, an average of 3 calls driven into the media platform 104 by the test tool 102 every 2 seconds (C3) may be selected. Additionally, a variable call duration representing a length of each call connection has been selected. For example, a call duration of 45 seconds may be chosen to mimic the total call duration of listening to a recorded listing of movie showings and time schedules at a local cinema (C4). The program then applies the user chosen input variables in order to test the responsiveness of a media platform 104 to the selectably chosen variable call distribution pattern and variable call duration. As noted above, the program can randomize the selectably chosen call distribution pattern and selectably chosen call duration around these chosen values as may likely occur in actual media platform use.

As illustrated, each of these input variables, C1, C2, C3, and C4, as well as others, can be independently chosen to selectably configure a test routine that will be driven by the test tool 102 into the media platform 104. Using the program embodiments described herein, a user testing a media platform can selectably adjust the input variables to model the random nature in which call signals are received by a media platform in an actual commercial use setting installed on a network.

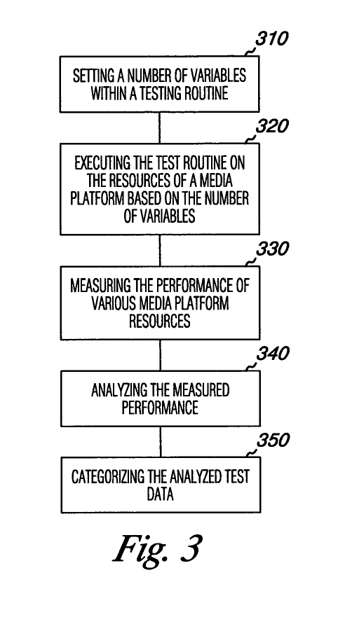

As described above, each of the input variables to the program can be independently and incrementally definable, and can repeatedly cycle through each test routine (e.g., routine 1., 2., and/or 3.) and/or multiple combinations of the test routines to execute in multiple iterations. In this manner, the test tool 102 can test multiple application characteristics on the media platform 104 as associated with one or more telecommunication service applications. In this embodiment, the test tool 102 can measure how well pre-selected, fixed media platform resources (e.g., switches, routers, processors, digital signal processing (DSP) modules, memory, media cards, and the like) will respond to call signaling conditions that would likely be encountered in actual use. Embodiments of the operation of the program are described in more detail in connection with FIGS. 3-5.

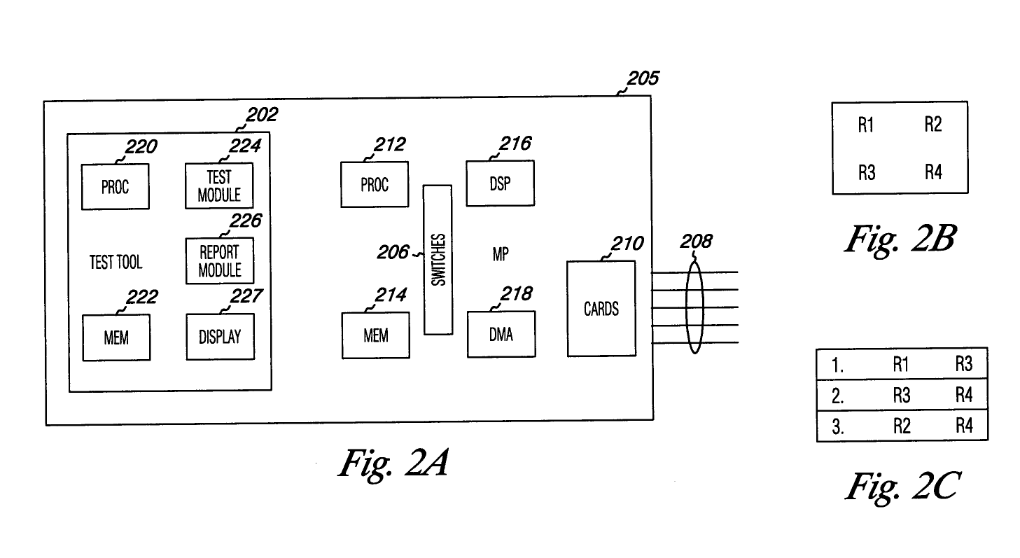

FIG. 2A is a block diagram of an embodiment of a media platform simulator 205. For ease of illustration, the media platform simulator 205 is shown including test tool 202. Test tool is illustrated with a processor 220 a memory 222, a testing module 224, and a test data analysis and output module 226. The test tool 202 includes a program for executing a testing routine based on selected input variables which represent one or more application characteristics for one or more telecommunications applications as described in connection with FIGS. 1A-1C. Thus, test tool 202 equates to test tool 102 described in connection with FIG. 1A and provides all of the functionality described therewith. The media platform simulator 205 includes all of the capabilities described in connection with the embodiments described in 1A-1C, but further includes the ability to mimic various hardware and software resources that could exist on a media platform. FIGS. 2B and 2C will illustrate in more detail the manner in which the resources of a media platform can be selectably chosen as a number of input variables in connection with implementing a particular testing routine.

In the embodiment of FIG. 2A, the test tool 202 is shown included on the media platform simulator 205. However, embodiments of the invention are not so limited. That is, in some embodiments the test tool 202, including the added functionality described below, can be a separate device as illustrated in the embodiment configuration shown in FIG. 1A.

For illustration purposes, FIG. 1A is provided to demonstrate connecting a test tool 102 to a physically constructed commercial media platform 104. FIG. 2A, is provided to discuss added functionality which allows for resources which would be potentially supplied on a finished media platform to be variably mimicked as well. It is noted that the media platform simulator 205 can be an entirely self-contained simulator, or alternatively, the test tool 202 can be separately connected as shown in FIG. 1A.

In the embodiment of FIG. 2A, the media platform simulator 205 allows not only for one or more telecommunication service application characteristics be selectably chosen as input variables, but additionally, the media platform resources themselves can be variably defined. The discussion connected with FIG. 1A describes a configuration in which the resources of the commercial media platform 104 under test are static in that they have been physically implemented on a media platform 104. In the embodiment discussion of FIG. 2A, resources of a media platform will be mimicked by the media platform simulator 205, using a test tool 202 on or off of the simulator, in order to simulate the resources which could be provided or actually constructed on a media platform.

By way of example and not by way of limitation, the resources of a media platform which can be mimicked by the media platform simulator 205, using a test tool 202 on or off of the simulator, include the size of a switch 206 that may actually be implemented on a commercial media platform. As another example, the resources of a media platform which can be mimicked by the media platform simulator 205 include the number of media channels 208 that may actually be implemented on a commercial media platform. And, as the reader will appreciate, mimicking resources such as the number of media channels 208 can include mimicking the presence of media cards, such as T1 or E1 media cards 210, on a media platform. Embodiments of the invention, however, are not so limited. Other media platform resources which can be variably defined include processor 212 and memory 214 resources as well as digital signal processing (DSP) 216 and direct memory access (DMA) 218 resources. As used herein, the variably defined resources can also be referred to as configurable resources.

In the embodiment of FIG. 2A the testing module 224 includes a program through which the media platform resources themselves can be variably defined. That is, the program can receive a number of input variables representing configurable media platform resources.

FIG. 2B illustrates an embodiment of a number of input variables representing configurable media platform resources. The input variables can be presented to a user of the media platform simulator 205 on a display 227 upon selection of a particular testing routine such as from memory 222. FIG. 2B shows example input variables representing configurable media platform resources as R1, R2, R3, and R4. The number of input variables are to model, or simulate the presence of a variety of resource capabilities (e.g., switches, routers, processors, digital signal processing (DSP) modules, memory, media cards, and the like). These input variables include a selectable number of media channels (R1), e.g., multiple T1 and/or E1 media cards. The input variables include a selectable amount of processing resources (R2), e.g., processors, DMA circuitry, DSP capabilities, and application modules of the like. The input variables include a selectable amount of network connects (R3), e.g., a variable size of the switch. And, the input variable can include a selectable amount of memory resources (R4). Embodiments of the invention, however, are not limited to these examples.

FIG. 2C illustrates an embodiment of a selected number of input variables representing configurable media platform resources for executing a test routine. By allowing a user of the test tool 202, whether on or off of the simulator, to select these input variables, the simulator can test the sufficiency of various resource configurations according to various telecommunication service applications. The results can be analyzed by the test tool 202 prior to physically constructing a particular media platform.

FIG. 2C illustrates an embodiment of a selected number of input variables representing media platform resources for executing a test routine. The example inputs shown have been selected or chosen from options such as those in FIG. 2B for purposes of executing a testing routine by the test tool 202. For illustration, to program, or configure a first (1.) test routine a user has selectably chosen as an input variable a number of media channels (R1). By way of example and not by way of limitation, R1 can be selected to represent 2 DS3 media cards for a total 1,344 voice circuits. Likewise, R1 can be selected to represent 4 T1 media cards. If each T1 media card has four spans, then a total of 384 voice circuits (4 media cards×4spans/TMC×24voice circuits/span) would be tested. Embodiments of the invention are not limited to these examples. In the first (1.) test routine a size of the switching capability (R3) has been selected as well. The software program can use this input to test the performance of the configuration with various telecommunication service applications, such as described in connection with FIGS. 1A-1C.

In a similar manner, a second test routine (2.) can be configured as shown in the embodiment of FIG. 2C, using I/O device 227. In the second test routine (2.) a size of the switching capability (R3) has been chosen as an input variable, and a size of memory resources (R4) has also been selectably set.

The embodiment of FIG. 2C further illustrates a third test routine (3.). In the third test routine (3.) an amount of processing resources (R2) has been selected for testing together with a certain size of memory resources (R4). As above, the software program can use this input to test the performance of the configuration with various telecommunication service applications, such as described in connection with FIGS. 1A-1C.

As illustrated, each of these input variables, R1, R2, R3, and R4, as well as others, can be independently chosen to selectably configure a test routine that will be driven by the test tool 202. Using the program embodiments described herein, a user testing a various configurations of media platform resources can selectably adjust the input variables to simulate presence of those resources on an actual media platform and to test the performance of the configuration with various telecommunication service applications, such as described in connection with FIGS. 1A-1C.

As described above, each of the input variables to the program can be independently and incrementally definable. The program can repeatedly cycle through each test routine (e.g., routine 1., 2., and/or 3.) and/or multiple combinations of the test routines to execute in multiple iterations and likewise in conjunction with various telecommunication service applications, such as described in connection with FIGS. 1A-1C.

In this manner, the test tool 102 can test multiple combinations of media platform resources in association with various telecommunication service applications and call signaling conditions as may likely be encountered in actual use.

The test tool embodiments described herein are operable to test the response of media platform resources to both signaling, e.g., the set up, tear down and bridging of calls, and media stream, e.g., message or call content simulation, according to selected input variables. Program embodiments are configurable to model multiple service applications across multiple T1 media cards, e.g., thousands of DS0s, based on a number of variably selected inputs.

FIGS. 3-5 illustrate various method embodiments for testing a media platform. Unless explicitly stated, the method embodiments described herein are not constrained to a particular order or sequence. Additionally, some of the described method embodiments or elements thereof can occur or be performed at the same point in time. As described herein, the embodiments can be performed by one or more programs (e.g., computer executable instructions) in connection with hardware, application modules, and the like, on the systems and devices shown herein or otherwise.

In the embodiments of FIGS. 3-5, a program is user configurable based on the variably selectable inputs to model multiple telecommunication service applications. As mentioned above, examples of service applications include voice mail, pre-paid calling, and information services, among others. These service applications can use interactive voice recognition (IVR) technology, dual tone multi frequency (DTMF) applications, and/or combinations thereof as the same have been described above. Different service applications have different application characteristics which include a length of a given recorded message or prompt, how long the media platform or system waits for a response, how long the media platform or systems takes to respond, and how interactive the application is.

Variable inputs can be provided through an I/O device to the program to define a call rate, a length of response, a call distribution pattern, and a call duration, among others. To illustrate the embodiments of FIGS. 3-5, examples for various service applications are described.

The method embodiment of FIG. 3, includes setting a number of variables within a testing routine program in block 310. Setting the number of input variables within the testing routine can be performed as described above in connection with FIGS. 1A-2C. As described above, each of the input variables can be independently and incrementally definable and provided using an I/O device.

One example of setting a number of input variables includes setting variables associated with a pre-paid calling card service application (e.g., a number of minutes paid in advance). A pre-paid calling card service application is interactive in requesting a user to enter a number of digits representing the user's account number.

In this example, setting a number of variables in block 310 includes setting variables to model how often the pre-paid calling service application is accessed. As described in connection with FIGS. 1B and 1C, this can include selecting a call rate and a call distribution pattern. The input variables set in association with the pre-paid can further define a length of a given message prompt, e.g., the length of a message prompt requesting the user's account number. The input variables can further define how much time is expected to elapse while the user of the service enters the digits representing the user's account number, e.g., how long the media platform or system waits for a response. For example, the input variables to the program can define a response time of 5 seconds while the user enters the account number.

In block 320, the method includes executing the testing routine on the resources of a media platform, such as media platform 104 in FIG. 1A, in order simulate multiple application characteristics associated with one or more service applications. In executing the testing routine with selected input variables associated with a pre-paid calling service, e.g., the call rate and the call distribution pattern, the length of a given message prompt requesting the user's account number, and the expected time period while a user responds with an account number, whether using IVR and/or DTMF, the program will drive call signals based on these input variable into the media platform. The resources of the media platform, e.g., switches, routers, processors, digital signal processing (DSP) modules, memory, media cards, and the like, will operate these call signals as if this were an actual pre-paid calling service user.

In block 330, the method includes measuring the performance of various media platform resources, e.g., switches, routers, processors, digital signal processing (DSP) modules, memory, media cards, and the like, in response to the test routine program. To measure the performance a test data analysis and output module, such as module 126 in FIG. 1A or module 226 in FIG. 2B, can receive input data, e.g., measurement results data, back from the program.

By way of example and not by way of limitation, the measurement result data may be a time measurement of how long a caller of the service would have waited after dialing the pre-paid calling number before receiving a recorded prompt. In other words, the amount of time which elapsed from the time the call signal was driven into the media platform and the media platform responded to the program with the recorded prompt. The measurement result data can also include a measurement of how long a caller of the service would have waited for an additional response after entering the information requested by the prompt. In other words, how long the media platform took to respond after a reply signal mimicking the IVR or DTMF response to the prompt (set by the selected input variable) would have been driven back into the media platform.

In the pre-paid calling card example, the load to the media platform is typically not very great while a user enters an account number. For example, the media platform does not have to do a lot while listing to Dual Tone Multiple Frequency (DTMF) key inputs. However, once that input is received the media platform will be active in retrieving the information associated with the particular account. The response time of the media platform to the account number input reply will vary depending on the call traffic selected for the testing routine by the number of input variables. That is, the number of callers mimicked by the program as trying to dial the particular pre-paid calling service at the same moment in time. The responsiveness of the media platform is also be impacted by the resources (e.g. processing resources, memory resources, and number of voice circuits, among others listed above) that are allocated to a particular telecommunication service on a media platform. Thus, the program can measure the response latency of the media platform to selected test routines input variables as a function of resources on the media platform.

In block 340, the method includes analyzing the measured performance (test data results) in order to determine the load and adequacy of the media platform's resources. For example, these measurements can be analyzed in the context of the variably defined inputs, e.g., the input defined length of the message per activity, length of response, etc., and in view of how interactive the particular service application is.

The measured performance data can be analyzed according to a number of performance criteria. The performance criteria can be provided to the program via the I/O device. By way of example and not by way of limitation, the number of performance criteria can include a pattern of network bandwidth usage (e.g., the number and timing of media channels usage), a pattern of memory usage (e.g., how frequently and to what extent memory is accessed), a pattern of processor usage (e.g., how frequently and to what extent the processor resources are accessed, or occupied), a latency measurement per each activity associated with a connection, or call, separated by service connection type, as well as an average latency per connection and average latency for all connections by service connection type.

As shown in block 350, the analyzed test data can be categorized and output as categorized performance report data. The number of performance criteria and categorized performance report data can include programs which compare and organize output summaries of the measured media platform response times to one or more thresholds set according to a predicted tolerance of a caller of a pre-paid calling service.

The performance criteria, categories, and thresholds can similarly be provided to the program via the I/O device. The categories can include categories similar to or different from the analyzed performance criteria. Thus, by way of example and not by way of limitation, the categories can include network bandwidth usage (e.g., the number and timing of media channels usage), a pattern of memory usage (e.g., how frequently and to what extent memory is accessed), a pattern of processor usage (e.g., how frequently and to what extent the processor resources are accessed, or occupied), a latency measurement per each activity associated with a connection, or call, separated by service connection type, as well as an average latency per connection and average latency for all connections by service connection type. But, additionally thresholds can be set according to a predicted tolerance of a caller of a pre-paid calling service.

The categorized performance report data can then be used for configuring a media platform to accommodate a number of telecommunication service applications while endeavoring to efficiently employ the media platform's resource capability to its fullest when the media platform is in actual use.

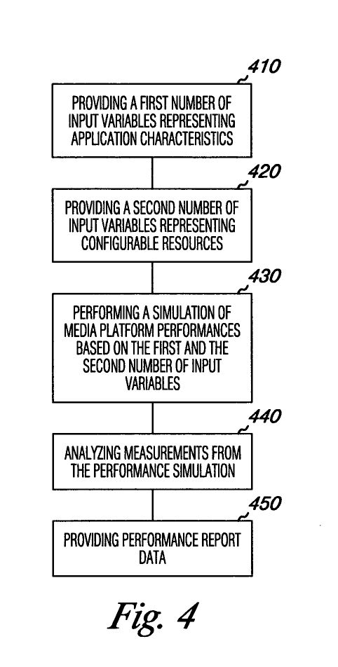

The embodiment of FIG. 4 is discussed in connection with another service application example to illustrate how the program can define configurable resources. That is, as described in connection with FIG. 2A, input variables to the program can define configurable resources, e.g., switches, routers, processors, digital signal processing (DSP) modules, memory, media cards, and the like, in addition to defining service application characteristics.

The example discussed here is that of a call service for information such as movie schedules or weather updates. In this example, the load to the media platform system may be large or small depending on the amount and location of the information to be retrieved.

The method embodiment of FIG. 4, illustrates providing a first number of input variables for one or more application characteristics of one or more service applications at block 410. As described in the embodiment of FIG. 3, the first number of input variables can define a call rate and call distribution pattern reflecting the call rate and distribution pattern of callers to a cinema's phone number having a recorded list of movie titles and the times those movies are showing at the cinema or to a weather information number having recorded weather updates for particular geographic regions. As described in connection with FIGS. 1A-1C, the input variables can be set to vary over time during a testing routine. As described above, the input variables for one or more application characteristics can include an input variable for a call duration. That is, input variables can be provided to represent that a call duration to a cinema's phone number of movie listing typically lasts 90 seconds and a call duration for weather information typically lasts 60 seconds.

As described above, the input variables for one or more application characteristics can include an input variable for variable recorded message lengths or recorded prompts associated with different activities in a particular service application, and a variable length of response time associated with the different activities of a particular service application, among others. By way of illustration, the recorded message length listing movie titles and the times those movies may be set for 30 seconds and/or have a 3 second recorded prompt asking the call “what movie.” By way of illustration, weather information number may also have a 3 second recorded prompt asking the caller “what geographic area” or “what town.” Once the caller replies the weather information number may have a 40 second recorded message of the weather in that area or town which may range from 15-45 seconds depending on the particular weather information relating to that area or town. As described in connection with FIGS. 1A-1C, all of the input variables can be set in the program to vary over time during a testing routine.

At block 420 in the embodiment of FIG. 4, the method further includes providing a second number of input variables representing configurable media platform resources. Typically the media platform is more active in retrieving information associated with an information service application and thus more media platform resources will be used. Hence, in this example the test routine will include a number of input variables to model the availability of different media platform resources. In this manner, the program can test the responsiveness of a media platform when different quantities of resources are provided to handle a telecommunication service such as information services.

The first and the second number of input variables can be provided to the program via the I/O device. In this embodiment, the second number of input variables can define a variable number of available media channels, e.g., multiple T1, E1, and/or J1 media cards, a variable amount of processing resources (including DMA circuitry, DSP capabilities, and application modules of the like), a variable amount of network connects, and a variable amount of memory resources, among others. By way of example and not by way of limitation, to provide a telecommunication service application such as movie information and/or weather updates, which may include both IVR (e.g., the “what movie” or “what town” questions) and DTMF (e.g., pressing a key on a phone to select a movie listing or town from a menu), more processing resources will likely be used than with the pre-paid calling card example. Likewise, more memory resources will likely be used to store longer recorded messages, i.e., the recorded listing of all movies showing or recorded weather updates. And, added media channels may be used based on the number of potential callers to the information service. Thus, the program allows various combinations of media platform resources to be selected and subjected to a test routine modeling various selected application characteristics associated with such information application services.

In block 430, the method includes performing a simulation, based on the first and the second number of input variables, to measure a performance of a media platform handling the one or more service applications thereon. For example, the test routine drives call signals modeling the various first selected input variables (e.g., one or more application characteristics associated with an information application service like movie listing or weather updates) into media platform resources which have been selected as a second set of input variables to test the adequacy of those selected resources in handling the characteristics of the application service. The simulation can record measurements on the interaction of one or more service applications running at the same time (e.g., movie listing and weather information service applications on the same media platform) according to the particular resource configuration defined by the second input variable for a media platform. As with the embodiment of FIG. 3, a latency of response by the media platform can be measured by the program.

A service application for information such as movie schedules and weather updates may have a latency of media platform response which is more noticeable by a user, e.g., an extended pause, while the system is waiting for the movie or weather information to be retrieved. In this example, the program can measure how long the media platform or system takes to respond with the information based on the defined first and second input variables.

In block 440, the method includes analyzing the measurements from the performed simulation. Analyzing the measurements in block 440 includes analyzing the impact, stress, or load placed on a particular set of media platform resources when running one or more service applications, e.g., movie listings and weather information applications. Analyzing the measurements in block 440 also includes analyzing the impact of the characteristics from one service application, for example the movie listing application, on the performance and behavior of another service application, for example the weather information application, based on the particular set of media platform resources selected according to the second set of input variables. Thus, a test routine executing the program, representing one or more service applications and a particular combination of media platform resources, can analyze a pattern of available network bandwidth usage (e.g., the number and timing of media channels usage), a pattern of memory usage (e.g., how frequently and to what extent memory is accessed), and a pattern of processor usage (e.g., how frequently and to what extent the processor resources are accessed, or occupied) as the testing routine is applied to the media platform. The test routine can analyze latency measurements per each activity (e.g., per each recorded message activity, per each recorded reply prompt, etc.) associated with a connection, or call, as separated by service connection type (e.g., movie listing and/or weather information), can analyze an average latency per connection (e.g., per each call for movie listings and/or weather information), and can analyze an average latency for all connections by service connection type (e.g., over a number of calls for movie listings and/or weather information). In this manner, the measurements can be analyzed in the context of the length of the message per activity and in view of how interactive the particular service application is. For example, the interactivity of a particular movie information service or weather information service will be determined by how much information is exchanged back and forth between the caller and the media platform. A movie information service or weather information service which by its design only plays recorded information is less interactive than a movie information service or weather information service which provides recorded prompts asking for a callers reply, e.g., prompts which ask “what movie?” or “what geographic area?” and then based on the callers reply selectively respond with information specific to the callers response.

In various embodiments, a number of thresholds can be defined as inputs to the program, via the I/O device, to sense or correlate how a user may interpret each operation or activity. In other words, certain input variables can be defined for use by the program to benchmark a system's performance according to the first and the second input variables. The thresholds can include configurable time thresholds representative of a user's tolerance to the system's response time. For example, a first threshold of five seconds can be associated with a satisfactory response time, a second threshold of 15 seconds can be associated with a marginally satisfactory response time. And, a third threshold of 30 seconds or more can be associated with an unsatisfactory response time. For example, a caller for movie listings may find it unacceptable to wait 30 second to receive movie information after their reply to a recorded prompt asking “what movie.” A variety or combination of thresholds can be included. Embodiments of the invention are not limited to the examples given above.

Analyzing the measurements in block 440 includes analyzing both the signaling performance , e.g., the set up, tear down and bridging of calls (connecting the caller to the movie listing or weather information sought), and media stream performance, e.g., message or call content accuracy in transmission (that is, was the correct movie listing information or weather information provided in response), while operating according to a simulation defined by the first and the second input variables.

In block 450, the method includes providing performance report data based on a number of categorized input data. That is, input data can define categories for the performance report data. As in the embodiment of FIG. 3, the performance report data can be categorized according to a number of particular points of analysis, e.g., signaling performance, media stream performance, and/or combinations thereof. In this manner, performance of a particularly configured set of media resources can be reviewed in response to the first and the second input variables. The performance report data can then be used to configure a media platform with a particular arrangement of resources in order to handle particular combinations of service applications. For example, using the thresholds discussed above, it may be determined that for a particular movie information service application or a weather information service application that more processing, memory, and/or media channels should be used to deliver satisfactory performance by the media platform in line with a caller's expectations.

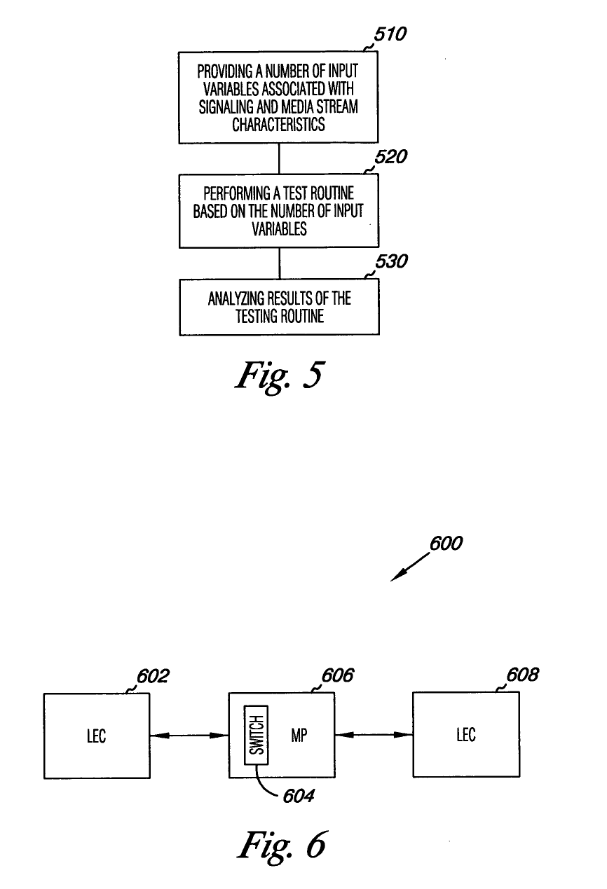

The embodiment of FIG. 5 is discussed in connection with another service application example. The example discussed here is a combined use of a voice response application, using interactive response (IVR), and the use of DTMF. An example of this combined usage may include a call to an information directory, such as a business directory or help line, and can also include an application for retrieving voice mail. In such examples, the call profile can be more complicated than a separate use of IVR or DTMF.

The method embodiment of FIG. 5, illustrates providing a number of input variables associated with signaling and media stream characteristics of a media platform at block 510. That is, the input variables are associated with both the signals used to set up, tear down and bridge of call connections and are associated with the message or call content. As described earlier, examples of telecommunication service applications which involve IVR and/or DTMF include caller information services such as calling a local cinema's telephone number for a listing of movie showings and times, calling a bank's telephone number to access account information, and/or calling a weather information number to receive weather forecasts. By way of example and not by way of limitation, an IVR service application would allow a caller to speak voice commands in response to recorded prompts, e.g., such as speaking a banking account number, or movie title, after a recorded prompt asking for “what account number” or “what movie listing.” The IVR will use the spoken response to set up, tear down, and bridge the call connection. In this example, the input variables can model recorded prompt and the caller's response. Based on the caller's response the IVR application would retrieve associated information, or recorded content. In this example, the input variables can also model the recorded content that would then be delivered based on the caller's response.

A DTMF service application would have a recorded prompt asking the caller to input the banking account number using keys on the phone, or to input the movie title using keys on the phone corresponding to the first several letters of the movie title. Based on the response tones received, the DTMF service application would respond by providing a caller with associated information. Again, in this example the input variables can model these associated actions.

It has been noted that sometimes a telecommunications service application involves a combination of IVR and DTMF responses. The embodiment of FIG. 5 accounts for providing input variables associated with the signaling, e.g., the set up, tear down, and bridging of calls for IVR and/or DTMF service applications, as well as the media content, e.g., the media stream characteristics associated with these services, either together or independently.

Accessing voice mail remotely is another example which can use IVR, DTMF, or a combination thereof. That is, a caller may dial a voice mail access number from a phone and either speak, press keys on their phone, or a combination thereof in response to recorded prompts in order to access their voice mail messages. The input variables provided at block 510 can be selected to model the exchange that would occur between the caller and the voice mail application on the media platform for testing purposes. As has been discussed in connection with the embodiments of FIGS. 3 and 4, the program can model a profile, including a combined IVR/DTMF profile, based upon a selection or entry of a number of variables in order to impose a load on the media platform system. The embodiments of the invention are not limited to the above examples.

In block 520, the method includes performing a test routine based on the number of input variables. In performing a test routine, the program will drive call signals into a media platform based on the input variables selected for IVR application characteristics, DTMF application characteristics, and/or both to test the signaling and media stream performance of these applications on the media platform. As noted earlier, in each of the above examples, a caller who has dialed a number of the respective telecommunications service will experience a certain response time before receiving a recorded prompt, and will experience a certain response time after the information requested by the prompt has been entered.

The program can measure the response of the resources of the media platform in order to determine the performance of the media platform under a particular configuration of resources and/or service application characteristics. As discussed in the embodiments above, based on user selectable input variables, the program can simulate a response time of a computer based IVR according to a number of configurable thresholds and can simulate additional response times for transferring the call to a call center when additional information or assistance is used. In each case, the program can simulate response times of the system according to the configurable thresholds and can simulate response times of a user to measure performance of a media platform.

In block 530, the method further includes analyzing results of the testing routine to determine the performance capabilities of the media platform. As before, the configurable thresholds for performance analysis can be selectable for a particular testing routine. That is, a program can be selected from memory, such as memory 122 of the test tool 102 or memory 222 of test tool 202, and a number of variables can be entered to the program to measure and analyze the performance of a media platform executing various service applications, e.g., the IVR and DTMF type applications described above, when certain media platform resources are available. Analyzing the results includes analyzing the performance of a number of resources associated with the media platform, as has been described in detail in connection with FIG. 4.

Embodiments described herein have been illustrated for programs on a robust test tool and/or media platform simulator with integrated signaling and media stream testing and analysis capabilities. More accurate measurements of performance can be realized than from test tools which only independently test the signaling and media stream functions of a media platform or which only independently test a subset of components. Particular pre-written applications do not have to be created for each service application to be tested. Test data collected by the media simulator can be analyzed and provided in a selectably categorized output format. In this manner, the test data collected from the media platform simulator can be used to more succinctly configure media platform resources, e.g., memory, media cards, network connections, and the like, to the actual use behavior of the media platform. In this manner, embodiments of the invention make it less likely that a media platform will have inadequate resources, resulting in user service dissatisfaction, when placed in use. In other words, embodiments of the invention make it less likely that the full resource capabilities of a media platform will be conservatively under-approximated to ensure satisfactory performance and less likely that the true resource capability of the media platform will be underutilized when placed in actual use.

FIG. 6 is a block diagram embodiment of a telecommunications network 600 which may include service applications for a telecommunications user. A telephone call may be placed by various telecommunication enabled devices, such as cell phones, multifunction devices (PDAs), and the like, which are operable to connect to a network 600. The network may include one or more of a variety of serving networks, including but not limited to, Publicly Switched Telephone Networks (PSTNs) Global System for Mobile communications (GSM) networks, American National Standards Institute (ANSI) networks, Public Wireless Local Area Networks (PWLANs), and/or Internet Protocol (IP) networks to name a few.

For purposes of illustration, a telephone call may be described as originating with a local exchange carrier (“LEC”) network 602. The LEC propagates the call to a switch 604, such as an originating switch or a terminating switch which can reside on a telecommunications platform, or media platform 606. The originating switch processes the telephone call and routes the call to its destination 608. The destination may be in a different LEC, a call bank, or in a different type of telecommunications network, such as those mentioned above.

The media platform 606 can include a media platform which has been configured using a test tool or a media platform simulator as the same have been described herein. The media platform 606 has been configured to ensure desired performance in handling a number of service applications while utilizing the true resource capability of the media platform 606. In other words, the resource capability of the media platform 606 has not been conservatively under-approximated to ensure satisfactory performance in actual use.

The media platform 606 can be a proprietary telecommunications platform. However, the telecommunications platform can also include a private branch exchange (PBX), a switching center such as a mobile switching center (MSC), or a local exchange office, among others. As noted above, media platforms include hardware and software resources in the form of switches, routers, processors, digital signal processing (DSP) modules, memory, media cards, and the like which can operate on or according to computer executable instructions.

For example, the originating switch 604 may determine when processing for services is required for a telephone call. When processing for services is required, the originating switch opens a dialogue with the media platform, exchanging with the media platform 606 higher-level protocol messages embedded within lower-level SS7 protocol messages.

Signaling System 7 (“SS7”), is a well known dialogue-based communications protocol used for signaling and which may be used for communications with computing platforms such as a telecommunications media platform. The data exchanged using the SS7 protocol interface between an originating switch and a media platform is commonly formatted into intelligent network application protocol (“INAP”) messages. At the end of the exchange of INAP messages that comprises a dialogue between an originating switch 604 and a media platform 606, the media platform 606 directs the originating switch to connect the telephone call to a final destination 608 in order to facilitate the transfer of a media stream, e.g., voice, data, and/or video.

Although specific embodiments have been illustrated and described herein, those of ordinary skill in the art will appreciate that an arrangement calculated to achieve the same techniques can be substituted for the specific embodiments shown. This disclosure is intended to cover adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. § 1.72(b) requiring an Abstract that will allow the reader to quickly ascertain the nature of the technical disclosure. It is submitted with the understanding that it will not be used to limit the scope of the claims.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A test tool to provide input to a media platform, comprising:
a processor associated with the test tool;
a memory coupled to the processor;
a program executable in connection with the processor and the memory, the program to test various media platform resources; and
wherein to test the various media platform resources the program can receive a number of selectable input variables, the number of selectable input variables to simulate multiple application characteristics associated with a service application on the media platform.

2. The test tool of claim 1, wherein the number of selectable input variables represent configurable media platform resources.

3. The test tool of claim 1, wherein the number of selectable input variables are independently and incrementally definable.

4. The test tool of claim 1, wherein the service application includes a service application selected from the group of voice mail, interactive voice recognition (IVR) services, and dual tone multi frequency (DTMF) applications.

5. The test tool of claim 1, wherein the number of selectable input variables include a call rate, a length of response time, a message time length, a call distribution pattern, and a call duration.

6. The test tool of claim 5, wherein the call rate is variable in increments of milliseconds, and wherein each of the number of selectable input variables can cycle through multiple combinations in multiple iterations.

7. The test tool of claim 1, wherein the various media platform resources include resources selected from the group of memory, media channels, network interconnects, processing capability, and application module resources.

8. The test tool of claim 7, wherein the media channels include media channels in a T1 or E1 media card.

9. A media platform call simulator, comprising:
a processor;
a memory coupled to the processor;
a program executable in connection with the processor and the memory, the program to simulate a performance of various media platform resources handling various service applications; and
wherein to simulate a performance of various media platform resources handling various service applications the program receives a first number of input variables representing one or more application characteristics of one or more service applications, and wherein the program receives a second number of input variables representing configurable media platform resources.

10. The simulator of claim 9, wherein the first number of input variables representing one or more application characteristics can define:
a call distribution pattern which varies over time during a testing routine;
a call duration which varies over time during a testing routine;
one or more message lengths associated with different activities in a particular service application; and
one or more length of response times associated with the different activities of a particular service application.

11. The simulator of claim 9, wherein the second number of input variables representing configurable media platform resources can define:
a number of available media channels;
an amount of processing resources;
a number of network connections; and
an amount of memory resources.

12. The simulator of claim 9, wherein first and the second number of input variables are independently and incrementally definable.

13. The simulator of claim 9, wherein the program simulates a performance of both call signaling and call media stream.

14. The simulator of claim 13, wherein the program simulates the performance of both call signaling and call media stream across multiple T1 media cards and at least a thousand DS0s.

15. The simulator of claim 9, wherein the program outputs categorized performance report data.

16. The simulator of claim 15, wherein the categorized report data can be organized according to a number of performance criteria, wherein the performance criteria include:
a pattern of available network bandwidth usage;
a pattern memory usage;
a pattern of processor usage; and
a latency measurement per each activity associated with a connection, the latency measurement can be separated by service connection type, as well as an average latency per connection and average latency for all connections by service connection types.

17. A simulation system, comprising:
a processor;
a memory coupled to the processor;
means for simulating one or more application characteristics of one or more service applications; and
means for simulating configurable media platform resources.

18. The simulation system of claim 17, wherein the means for simulating one or more application characteristics of one or more service applications includes a program executable on the system to provide a number of independent input variables associated with the one or more application characteristics of one or more service applications.

19. The simulation system of claim 17, wherein the means for simulating configurable media platform resources includes a program executable on the system to provide a number of independent input variables associated with configurable media platform resources.

20. A media platform produced using the simulation system of claim 17, wherein the media platform handles a number of service applications without under-utilizing the resource capability of the media platform.

21. A method for testing a media platform, comprising:
selecting a number of scalable variables to define one or more application characteristics for different service applications;
executing a testing routine which implements the selected number of scalable variables;
measuring the performance of various media platform resources while executing the testing routine;
analyzing the measured performance; and
providing categorized performance report data.

22. The method of claim 21, wherein selecting a number of scalable variables to define one or more application characteristics includes:
independently and incrementally defining the number of scalable variables such that multiple increments can be defined for each of the number of variables; and
cycling through multiple combinations of the incrementally defined number of scalable variables in multiple iterations while executing the testing routine.

23. The method of claim 21, wherein executing a testing routine includes executing a repeatable testing routine useable for a number of different service applications and executing a variable testing routine based on the number of scalable variables.

24. The method of claim 21, wherein a different set of the number of scalable variables can be associated with the different service applications, and wherein the different service applications can be selected from a memory.

25. The method of claim 21, wherein analyzing the measured performance includes analyzing the measured performance according to a number of criteria, wherein the criteria includes:
a pattern of available network bandwidth usage;
a pattern memory usage;
a pattern of processor usage; and
a latency measurement per each activity associated with a connection, the latency measurement can be separated by service connection type, as well as an average latency per connection and average latency for all connections by service connection types.

26. A method for testing a media platform, comprising:
providing a first number of input variables representing one or more application characteristics of one or more enhance service applications;
providing a second number of input variables representing configurable media platform resources;
performing a simulation, based on the first and the second input variables, to measure a performance of a media platform handling the one or more service applications thereon;
analyzing results from the performed simulation; and
providing performance report data based on a number of categorized input data.

27. The method of claim 26, wherein providing a first number of input variables representing one or more application characteristics of one or more service applications includes providing a first number of input variables selected from the group of:
a variable number of available media channels;
a variable amount of processing resources;
a variable amount of network connections; and
a variable amount of memory resources.

28. The method of claim 26, wherein providing a second number of input variables representing configurable media platform resources includes providing a second number of variables selected from the group of:
a call rate which varies over time during a testing routine;
a call duration which varies over time during a testing routine;
variable message lengths associated with different activities in a particular service application; and
a variable length of response time associated with the different activities of a particular service application.

29. The method of claim 26, wherein performing a simulation based on the first and the second input variables includes measuring simulation interactions of the one or more service applications according to configurable media platform resources.

30. The method of claim 26, wherein analyzing results from the performed simulation includes analyzing an impact on a particular set of media platform resources when running one or more service applications.

31. The method of claim 30, wherein analyzing results from the performed simulation includes analyzing an impact of the characteristics from one service application on a performance of another service application for the particular set of media platform resources.

32. A computer readable medium having a program to cause a device to perform a method that comprises:
providing a number of input variables associated with signaling and media stream characteristics of a media platform;
performing a test routine based on the number of input variables; and
analyzing results of the testing routine to determine the performance capabilities of the media platform.
